(19) United States
(12) Patent Application Publication
(10) Pub. No.: US 2013/0170895 A1
(43) Pub. Date: Jul. 4, 2013

(54) FLOATING FASTENER WITH EXPANDED APPLICATION FLEXIBILITY

(71) Applicant: Ying-Chih TSENG, New Taipei City (TW)

(72) Inventor: Ying-Chih TSENG, New Taipei City (TW)

(21) Appl. No.: 13/342,575

(22) Filed: Jan. 3, 2012

(51) Int. Cl. F16B 1/00

(52) U.S. Cl. 403/270

(57) ABSTRACT

A floating fastener includes a mounting base member bonded to a first plate member, and a fastener, which includes a locking member inserted through the mounting base member and having a top connection end piece for fastening to a fastener at a third plate member to secure a third plate member to the first plate member in a stack, a bottom locking end piece for fastening to a second plate member to lock the second plate member to the first plate member in a stack, a knob affixed to a middle part of the locking member and slidably coupled to the mounting base member for operation by a user to fasten the locking member to the second plate member, and a spring member supporting the locking member in the mounting base member in a floating manner.

### BACKGROUND OF THE INVENTION

1. Field of the Invention

The present invention relates to fastener means for joining plate members and more particularly, to a floating fastener, which is practical for detachably fastening multiple plate members in a machine or electronic device in a stack, saving much machine or device space.

2. Description of the Related Art

When fastening plate members together, a fastening screw assembly formed of a knob, a mounting base member and a screw is usually used. During installation, the screw and the mounting base member are secured to the first plate member, and then the knob is rotated to drive the screw into the second plate member, and then a hand tool is used to fasten tight the screw, affixing the first and second plate members together. This design of fastening screw assembly can be used in a machine tool to join plate members together. In a machine tool where plate members are to be fastened together are commonly at the locations of the power drive and speed-adjustment unit. Further, the power drive and speed-adjustment unit of a machine toll are commonly arranged inside a housing. When the power drive or speed-adjustment unit fails, or when an adjustment of the speed of the power drive or speed-adjustment unit is necessary, the plate members must be unlocked. When unlocking the plate members, the component parts of the fastening screw assemblies may fall from the plate members and missed accidentally, affecting further re-installation operation.

Further, following rapid development of computer technology, many advanced and high-power computer, electronic and electrical products have been continuously created for different applications. In these products, multiple circuit boards that carry different CPUs, chips and component parts may be installed to expand the functions. However, installation of multiple circuit boards in a computer or electronic product occupies much the inside space of the computer or electronic product. Conventionally, screws and nuts are commonly used to lock plate members (circuit boards) in a computer or electronic product. In actual practice, using screws and nuts to lock plate members has the drawbacks as follows:
1. It is complicated to lock multiple plate members in a computer or electronic product by screws and nuts. Further, it requires much labor and time to unfasten the screws and nuts for removal of the plate members for maintenance or repair.
2. Using screws and nuts to lock two plate members (circuit boards) in a computer or electronic product in a stack does not allow installation of an extra plate member (circuit board) to the stacked plate members (circuit boards) to expand the function.

Therefore, it is desirable to provide a floating fastener, which allows quick mounting and dismounting of multiple plate members in a stack, facilitating maintenance and repair and saving much the installation space.

### SUMMARY OF THE INVENTION

The present invention has been accomplished under the circumstances in view. It is therefore an object of the present invention to provide a floating fastener with expanded application flexibility, which is practical for detachably fastening multiple plate members in a stack inside a machine or electronic device, fully utilizing the available machine or device space.

To achieve this and other objects of the present invention, a floating fastener comprises a mounting base member for bonding to a first plate member, which defines therein a first accommodation chamber, a second accommodation chamber and a partition wall disposed between the first accommodation chamber and the second accommodation chamber, and a fastener mounted in the mounting base member in a floating manner for detachably fastening a second plate member and a third plate member to the first plate member at two opposite sides. The fastener comprises a locking member for fastening to a spacer block at the second plate member and a fastener at the third plate member, a knob fixedly fastened to the locking member and axially slidably coupled to the periphery of the mounting base member for operation by a user to fasten the locking member to the second plate member, and a spring member mounted around the locking member inside the knob and stopped between the locating flange of the locking member and the partition wall of said mounting base member.

Further, the locking member is inserted through the mounting base member, comprising a bottom locking end piece suspending in the second accommodation chamber of the mounting base member and movable out of the second accommodation chamber of the mounting base member for fastening to the spacer block at the second plate member, a top connection end piece extending out of the first accommodation chamber of the mounting base member for the fastening of the fastener at the third plate member and a locating flange extending around the periphery thereof between the top connection end piece and the bottom locking end piece.

Further, the top connection end piece of the locking member comprises an outer thread extending around the periphery thereof and an axial screw hole for the fastening of the fastener at the third plate member. Further, the bottom locking end piece of the locking member is a locking screw threadable into a screw hole in the spacer block of the second plate member.

### BRIEF DESCRIPTION OF THE DRAWINGS

FIG. 1 is an elevational view of a floating fastener in accordance with a first embodiment of the present invention.

FIG. 2 is an exploded view of the floating fastener in accordance with the first embodiment of the present invention.

FIG. 3 is a sectional exploded view of the floating fastener in accordance with the first embodiment of the present invention.

FIG. 4 is a schematic sectional view of the first embodiment of the present invention, illustrating the mounting base member bonded to a first plate member before loading of the floating fastener.

FIG. 5 is a schematic sectional applied view of the first embodiment of the present invention, illustrating the floating fastener installed in the first plate member and locked to a second plate member before mounting of a third plate member.

FIG. 6 corresponds to FIG. 5, illustrating the third plate member locked to the floating fastener.

FIG. 7 is a schematic sectional view illustrating another application example of the floating fastener in accordance with the first embodiment of the present invention.

FIG. 8 is an exploded view of a floating fastener in accordance with a second embodiment of the present invention.

FIG. 9 is a schematic sectional applied view of the floating fastener in accordance with the second embodiment of the present invention (I).

FIG. 10 is a schematic sectional applied view of the floating fastener in accordance with the second embodiment of the present invention (II).

### DETAILED DESCRIPTION OF THE PREFERRED EMBODIMENT

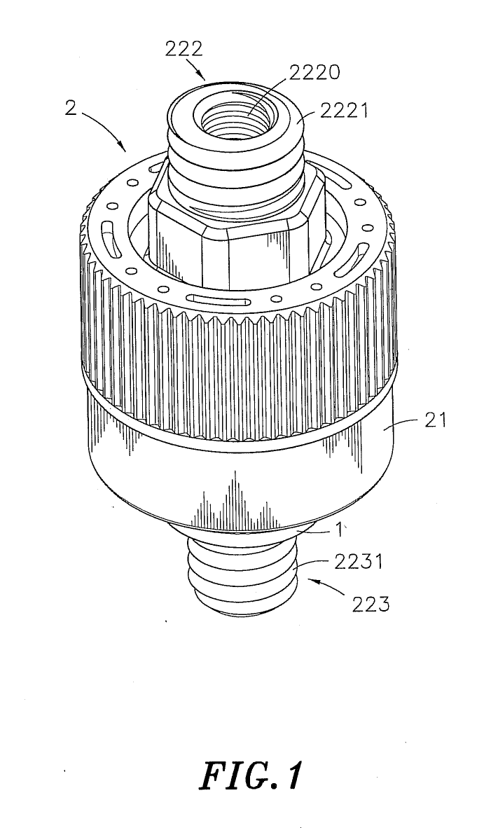

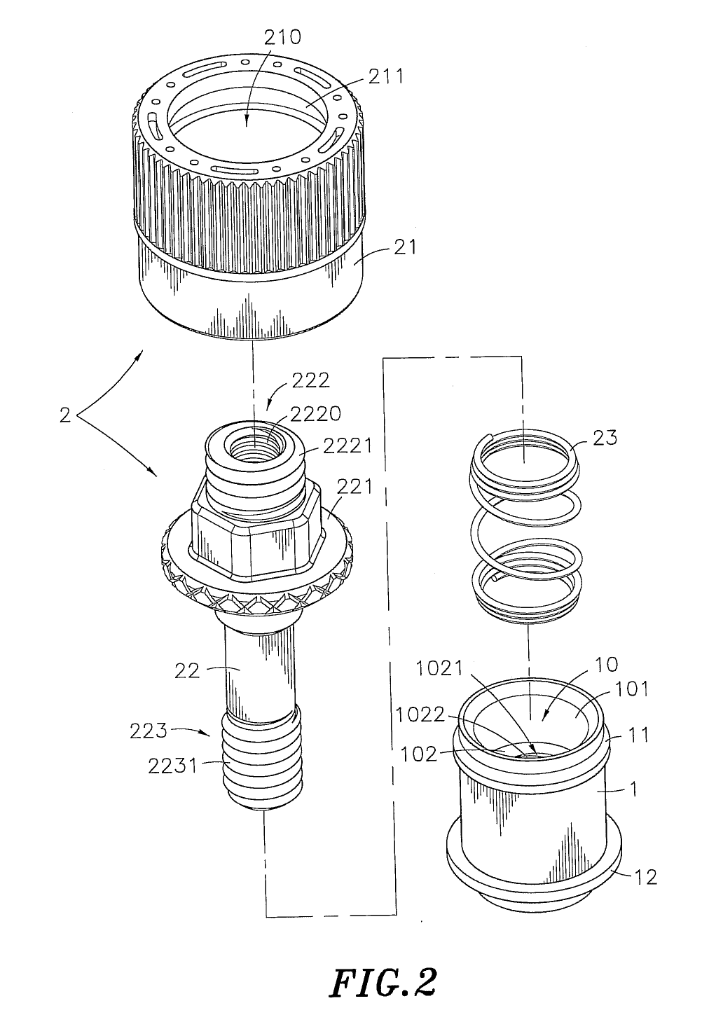

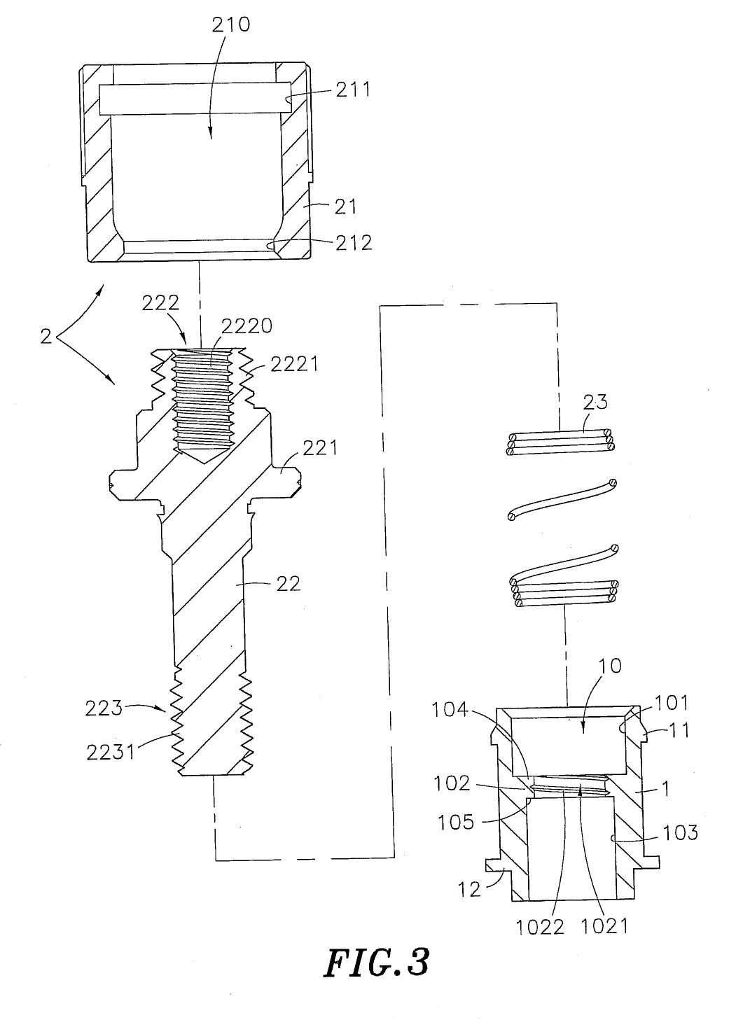

Referring to FIGS. 1, 2 and 3, a floating fastener with expanded application flexibility in accordance with a first embodiment of the present invention is shown. The floating fastener comprises a mounting base member 1 and a fastener 2.

The mounting base member 1 is a hollow cylinder defining therein an open space 10 that extends through opposing top and bottom ends thereof. The mounting base member 1 comprises a first accommodation chamber 101 formed of an upper part of the open space 10, a second accommodation chamber 103 formed of a lower part of the open space 10, a partition wall 102 transversely disposed in the open space 10 on the middle between the first accommodation chamber 101 and the second accommodation chamber 103, a through hole 1021 cut through the partition wall 102 in communication between the first accommodation chamber 101 and the second accommodation chamber 103, a first shoulder 104 formed of an upper part of the partition wall 102 and facing toward the first accommodation chamber 101, a second shoulder 105 formed of a lower part of the partition wall 102 and facing toward the second accommodation chamber 103, a stop flange 11 extending around the periphery thereof corresponding to the first accommodation chamber 101, and a bottom mounting structure 12 located on the bottom side thereof around the bottom end of the open space 10.

The fastener 2 comprises a knob 21, a locking member 22, and a spring member 23. The locking member 22 is a stepped cylindrical rod member comprising a top connection end piece 222, a bottom locking end piece 223, and a locating flange 221 extending around the periphery thereof between the top connection end piece 222 and the bottom locking end piece 223. The knob 21 is a hollow cylindrical cap member, comprising an accommodation open chamber 210 extending through opposing top and bottom sides thereof, an inside retaining groove 211 disposed inside the accommodation open chamber 210 near the top wall thereof, and a front coupling portion 212 inwardly protruded from the distal end of the peripheral wall thereof. The knob 21 is fastened to the locking member 22, keeping the locating flange 221 in engagement with the inside retaining groove 211 of the locking member 22 tightly. When the knob 21 and the locking member 22 are fastened together, the top connection end piece 222 of the locking member 22 suspends outside the knob 21. Further, the spring member 23 is mounted around the locking member 22 inside the knob 21 and stopped at the bottom side of the locating flange 221 of the locking member 22.

During installation, the locking member 22 of the fastener 2 is inserted through the open space 10 of the mounting base member 1, and then the front coupling portion 212 of the knob 21 is forced downwardly over the stop flange 11 of the mounting base member 1. When moving the knob 21 downwardly relative to the mounting base member 1, the knob 21 is elastically deformed, allowing the front coupling portion 212 of the knob 21 to move over the stop flange 11 of the mounting base member 1. After the front coupling portion 212 of the knob 21 has been moved downwardly over the stop flange 11 of the mounting base member 1, the knob 21 immediately returns to its former shape, and thus, the front coupling portion 212 of the knob 21 is axially slidably coupled to the periphery of the mounting base member 1 between the stop flange 11 and the bottom mounting structure 12. When the floating fastener is assembled, the spring member 23 is stopped between the locating flange 221 and the first shoulder 104 of the mounting base member 1, and the locking member 22 is movable with the knob 21 relative to the mounting base member 1.

The mounting base member 1 further comprises an inner thread 1022 formed in the through hole 1021 at the partition wall 102. Further, the diameter of the first accommodation chamber 101 of the mounting base member 1 is greater than the diameter of the second accommodation chamber 102; however, the vertical depth of the first accommodation chamber 101 is shorter than the vertical depth of the second accommodation chamber 102.

Further, the knob 21 and locking member 22 of the fastener 2 can be integrally made in one piece. Alternatively, the knob 21 and the locking member 22 can be separately made and then fixedly fastened together. The knob 21 is in a convenient configuration for grasping. By means of the knob 21, the operator can move or rotate the locking member 22 relative to the mounting base member 1 with less effort. Further, the bottom locking end piece 223 of the locking member 22 can be made in the form of a locking pin or locking screw. In this embodiment, the bottom locking end piece 223 is a locking screw, having an outer thread 2231 extending around the periphery thereof. Further, the top connection end piece 222 of the locking member 22 comprises an outer thread 2221 extending around the periphery thereof, and an axial screw hole 2220.

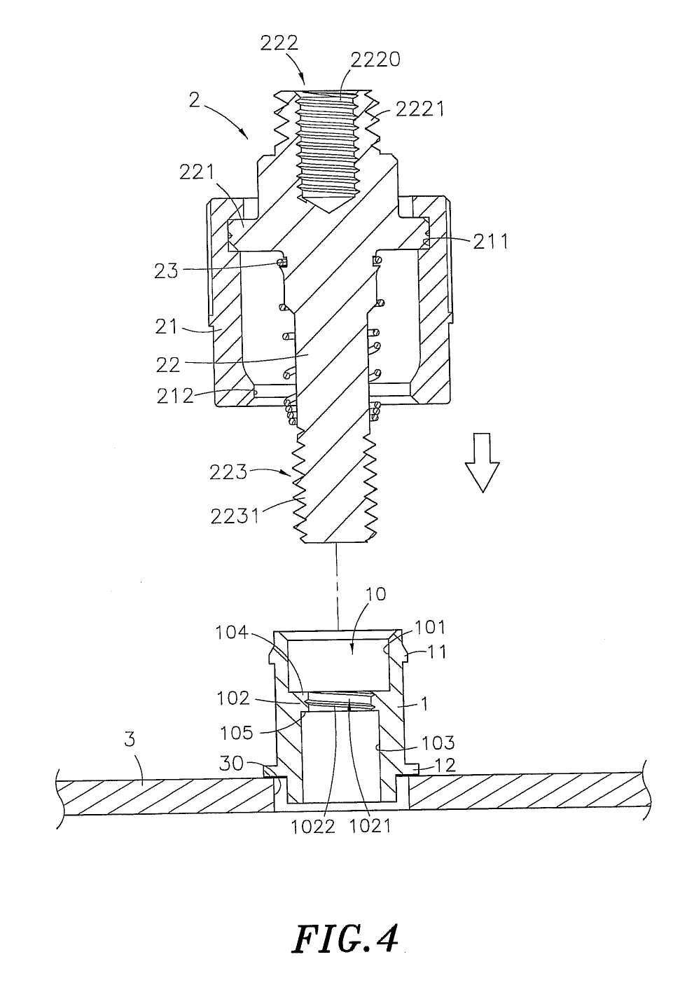

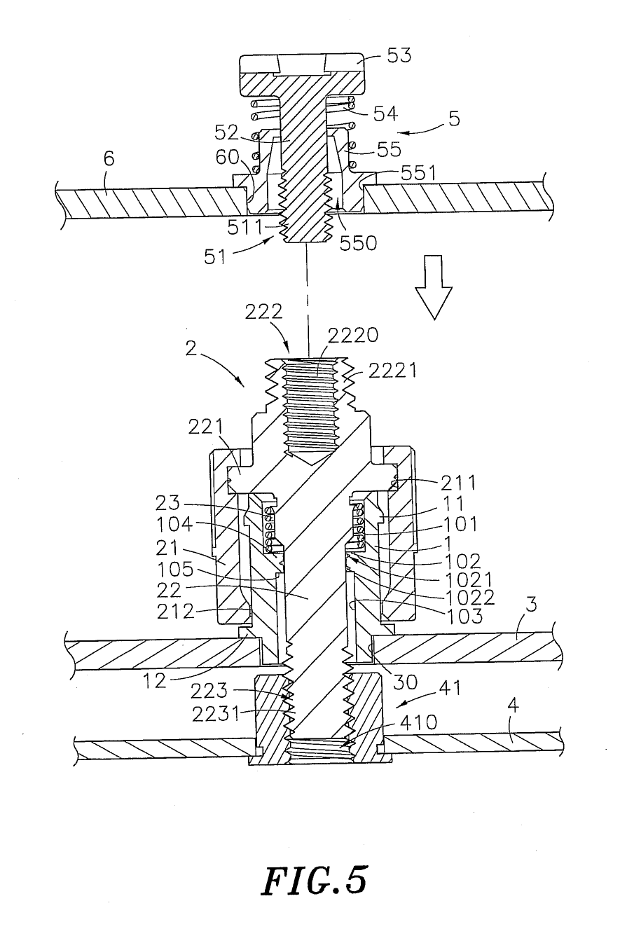

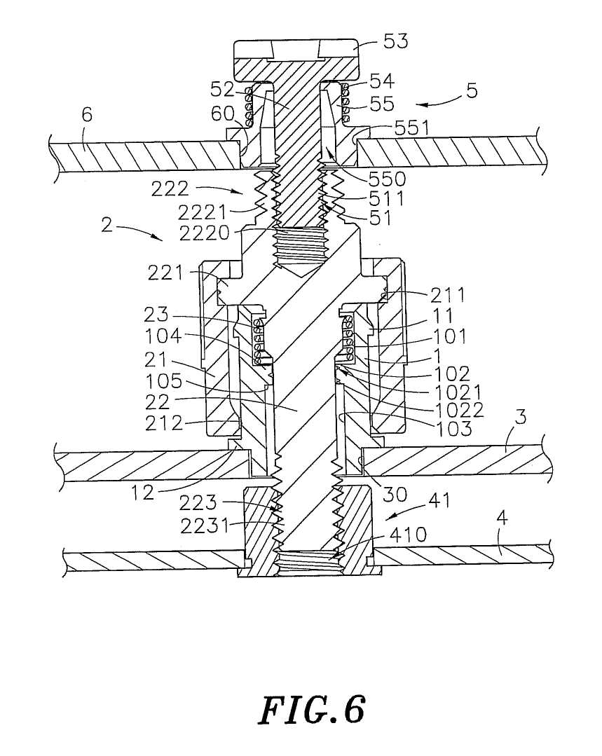

Referring to FIGS. 4, 5 and 6, by means of the bottom mounting structure 12, the mounting base member 1 is bonded to a mounting through hole 30 of a first plate member 3 by welding. Thereafter, the front coupling portion 212 of the knob 21 of the fastener 2 is axially slidably coupled to the mounting base member 1 at the first plate member 3 between the stop flange 11 and the bottom mounting structure 12. At this time, the spring member 23 is supported between the locating flange 221 of the locking member 22 and the first shoulder 104 of the mounting base member 1. Thus, the fastener 2 is supported on the mounting base member 1 in a floating manner. Thereafter, the knob 1 is moved downwards to lower the locking member 22 relative to the mounting base member 1, moving the bottom locking end piece 223 of the locking member 22 out of the bottom side of the mounting through hole 30 of the first plate member 3, and then the bottom locking end piece 223 of the locking member 22 is fastened to a spacer block 41 at a second plate member 4, locking the first plate member 3 and the second plate member 4 in a stack.

In this embodiment, the spacer block 41 defines therein an screw hole 410; the outer thread 2231 of the bottom locking end piece 223 of the locking member 22 is threaded into the screw hole 410 of the spacer block 41 at the second plate member 4.

Further, the spacer block 41 can be formed integral with a part of the second plate member 4. Alternatively, the spacer block 41 can be an independent member affixed to a hole in the second plate member 4.

Further, the top connection end piece 222 of the locking member 22 extends out of the top side of the knob 21 for the connection of a fastener 5 to lock a third plate member 6 to the floating fastener at the first plate member 3. The fastener 5 in this application example is a floating screw comprising a mounting base member 55 having a mounting portion 551 bonded to a mounting through hole 60 of the third plate member 6, a lock screw 51, which is inserted through a receiving space 550 in the mounting base member 55 and has an outer thread 511 extending around the periphery of the screw body 52 thereof and threadable into the axial screw hole 2220 of the top connection end piece 222 of the locking member 22 and an operating portion 53 located on the top side of the screw body 52 of the lock screw 51 for operation by the user to drive the screw body 52 into the axial screw hole 2220 of the top connection end piece 222 of the locking member 22, and a spring member 54 mounted around the screw body 52 of the lock screw 51 and the periphery of the mounting base member 55 and stopped between the head of the screw body 52 of the lock screw 51 and the top side of the mounting portion 551 of the mounting base member 55 to support the lock screw 51 in a floating manner relative to the mounting base member 55.

Further, the aforesaid first plate member 3 can be a plate member of a machine housing or a box member attachable to the machine housing; the second plate member 4 and third plate member 6 can be circuit boards to be mounted in machine housing or box member in a stack.

Further, the operating portion 53 of the lock screw 51 can be an embossment or coarsened wall, anti-slip stripes or raised elements located on the top side of the of the screw body 52 of the lock screw 51 for grasping by the hand. Alternatively, the operating portion 53 of the lock screw 51 can be a hexagonal nut, hexagonal socket, plum blossom-shaped tool hole, straight tool groove or crossed tool groove for the attachment of hexagonal wrench, box wrench or mating screwdriver to drive the lock screw 51 into the axial screw hole 2220 of the top connection end piece 222 of the locking member 22 of the floating fastener.

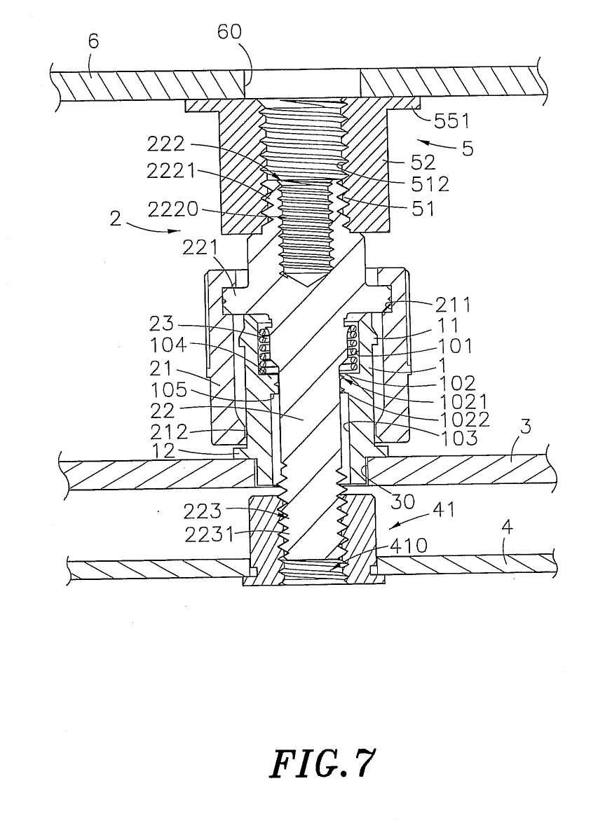

In the application example shown in FIG. 7, the mounting base member 55 of the fastener 5 is a nut having a mounting portion 551 fixedly bonded to the outside wall of the third plate member 6 around the mounting through hole 60 by welding or by means of an adhesive. The lock screw 51 of the fastener 5 is a stepped screw partially threaded into the inner thread 512 of the mounting base member 55 and partially threaded into the axial screw hole 2220 of the top connection end piece 222 of the locking member 22 of the floating fastener to lock the third plate member 6 to the floating fastener at the first plate member 3. Further, the outer thread 2221 of the top connection end piece 222 of the locking member 22 is also threaded into the inner thread 512 of the mounting base member 55, enhancing connection tightness

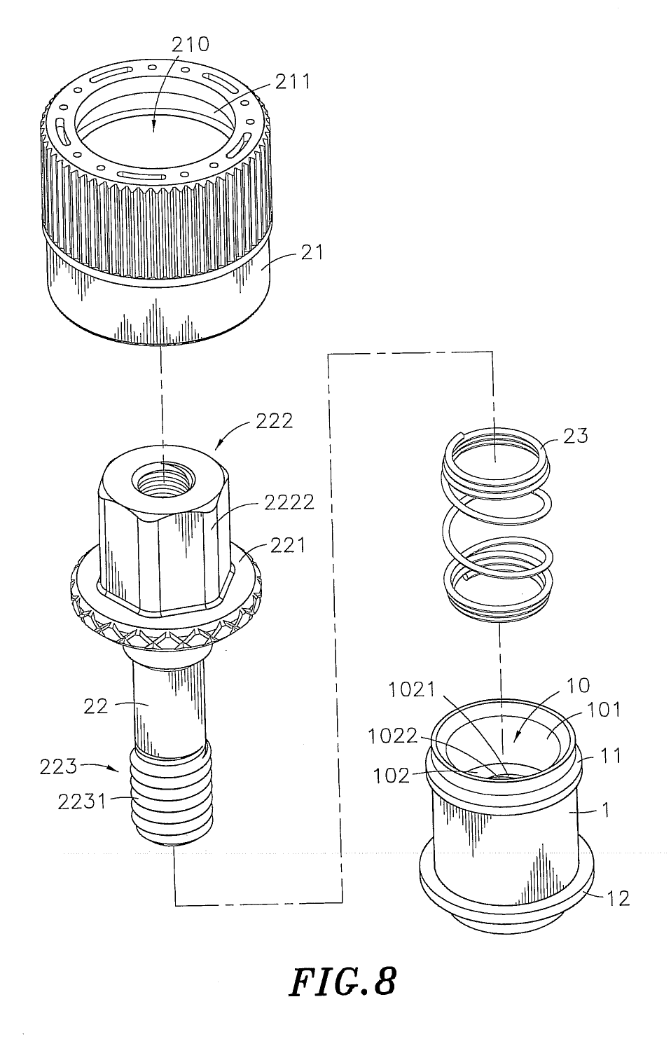

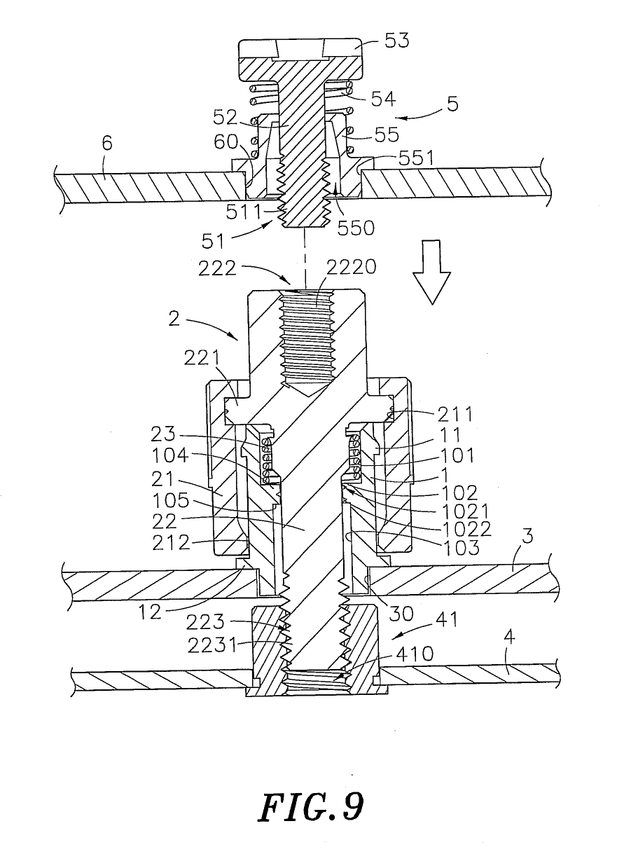

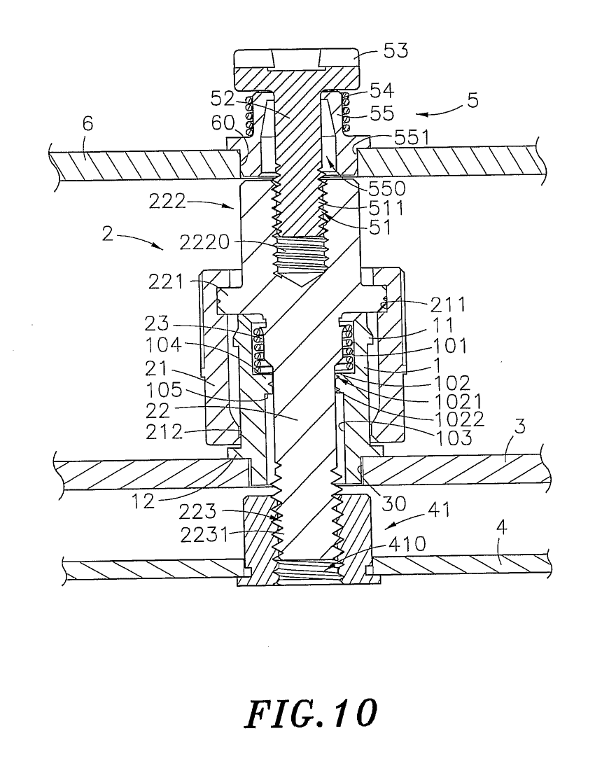

FIGS. 8, 9 and 10 illustrate a floating fastener in accordance with a second embodiment of the present invention. This second embodiment of the present invention is substantially similar to the aforesaid first embodiment with the exception of the configuration of the top connection end piece 222 of the locking member 22 of the floating fastener. According to this second embodiment, the top connection end piece 222 of the locking member 22 eliminates the aforesaid outer thread 2221, having a peripheral wall 2222 configured subject to a predetermined pattern. This second embodiment achieves the same effects of the aforesaid first embodiment, i.e., the floating fastener is mountable at a first plate member 3 to lock a second plate member 4 and a third plate member 6 in a stack.

As stated above, the invention provides a floating fastener, which comprises a mounting base member 1 for bonding to a first plate member 3, and a fastener 2, which comprises a locking member 22, which is inserted through an open space 10 in the mounting base member 1, comprising a top connection end piece 222 for fastening to a fastener 5 at a third plate member 6 to secure a third plate member 6 to the first plate member 3 in a stack, a bottom locking end piece 223 for fastening to a second plate member 4 to lock the second plate member 4 to the first plate member 3 in a stack and a locating flange 221 extending around the periphery thereof between the top connection end piece 222 and the bottom locking end piece 223, a knob 21 affixed to the locating flange 221 of the locking member 22 and slidably coupled to the mounting base member 1 for operation by a user to fasten the locking member 22 to the second plate member 4 or to unfasten the locking member 22 from the second plate member 4, and a spring member 23 mounted around the locking member 22 and stopped between the locking flange 221 of the locking member 22 and a part of the mounting base member 1 to support the locking member 22 in a floating manner. Subject to the use of the floating fastener of the present invention, multiple plate members can be detachably fastened in a stack and kept apart from one another, fully utilizing available device space.

In conclusion, the invention provides a floating fastener, which has features and advantages as follows:
1. The knob 21 is affixed to the locating flange 221 of the locking member 22 and axially slidably coupled to the mounting base member 1 for operation by the user to fasten the locking member 22 to the second plate member 4 or to unfasten the locking member 22 from the second plate member 4 conveniently with less effort.
2. After installation of the mounting base member 1 in a first plate member 3 and fastening of the locking member 22 to lock a second plate member 4 to the first plate member 3, the top connection end piece 222 of the locking member 22 can be fastened to a fastener 5 at a third plate member 6 to secure a third plate member 6 to the first plate member 3 in a stack.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A floating fastener, comprising:
a mounting base member adapted for bonding to a first plate member, said mounting base member comprising an open space extending through opposing top and bottom sides thereof, a first accommodation chamber formed of an upper part of said open space, a second accommodation chamber formed of a lower part of said open space, a partition wall transversely disposed in said open space between said first accommodation chamber and said second accommodation chamber, a through hole cut through said partition wall in communication between said first accommodation chamber and said second accommodation chamber; and
a fastener mounted in said mounting base member and fastenable to a second plate member to lock said first plate member to said second plate member, said fastener comprising a locking member inserted through said open space of said mounting base member, said locking member comprising a bottom locking end piece for fastening to said second plate member to lock said first plate member to said second plate member, a top connection end piece for the fastening of a fastener at a third plate member to secure said third plate member to one side of said first plate member opposite to said second plate member and a locating flange extending around the periphery thereof between said top connection end piece and said bottom locking end piece, a knob fixedly fastened to said locating flange and axially slidably coupled to the periphery of said mounting base member for operation by a user to fasten said locking member to said second plate member, and a spring member mounted around said locking member inside said knob and stopped between said locating flange of said locking member and said partition wall of said mounting base member.

2. The floating fastener as claimed in claim 1, wherein said first accommodation chamber of said mounting base member has a diameter greater than said second accommodation chamber, and a vertical depth shorter than said second accommodation chamber.

3. The floating fastener as claimed in claim 1, wherein said mounting base member further comprises a first shoulder formed of an upper part of said partition wall and facing toward said first accommodation chamber, and a second shoulder formed of a lower part of said partition wall and facing toward said second accommodation chamber.

4. The floating fastener as claimed in claim 1, wherein said mounting base member further comprises an inner thread formed in the through hole at said partition wall.

5. The floating fastener as claimed in claim 1, wherein said knob is formed integral with said locating flange of said locking member, defining therein accommodation open chamber; said top connection end piece and bottom locking end piece of said locking member respectively extended out of opposing top and bottom sides of the accommodation open chamber of said knob; said bottom locking end piece of said locking member is in the form of a locking pin.

6. The floating fastener as claimed in claim 1, wherein said mounting base member further comprises a stop flange extending around the periphery thereof at a top side, and a bottom mounting structure located on a bottom side thereof for bonding to said first plate member; said knob comprises an accommodation open chamber extending through opposing top and bottom sides thereof, an inside retaining groove disposed inside said accommodation open chamber and fixedly fastened to said locating flange of said locking member, and a front coupling portion inwardly protruded from a bottom end of the peripheral wall thereof and axially slidably coupled to the periphery of said mounting base member between said stop flange and said bottom mounting structure.

7. The floating fastener as claimed in claim 1, wherein said top connection end piece of said locking member is polygonal rod member defining therein an axial screw hole; said bottom locking end piece of said locking member is a locking pin.

8. The floating fastener as claimed in claim 1, wherein said top connection end piece of said locking member comprises an outer thread extending around the periphery thereof and an axial screw hole; said bottom locking end piece of said locking member is a locking screw.
